(19) United States
(12) Patent Application Publication
(10) Pub. No.: US 2021/0354221 A1
(43) Pub. Date: Nov. 18, 2021

(54) ELECTROLYTIC PROCESSING APPARATUS AND METHOD THEREOF

(71) Applicant: National Taiwan Normal University, Taipei City (TW)

(72) Inventors: Shun-Tong CHEN, Taipei City (TW); Wei-Jie CHIU, Taipei City (TW)

(21) Appl. No.: 17/032,742

(22) Filed: Sep. 25, 2020

(30) Foreign Application Priority Data
May 15, 2020 (TW) 109116207

(51) Int. Cl. B23H 3/04; C25F 3/14; C25F 7/00

(52) U.S. Cl. CPC B23H 3/04; C25F 7/00; C25F 3/14

(57) ABSTRACT

An electrolytic processing apparatus configured for processing a hole of a work piece. The electrolytic processing apparatus includes a work platform, an electrolyte providing device and an electrolytic electrode. The work platform includes a loading platform and a flow channel. When the loading platform loads the work piece, the position of the flow channel is corresponding to that of the hole. The electrolyte providing device connects to the flow channel to provide an electrolyte to the hole through the flow channel. The electrolytic electrode is configured relative to the work platform and moves in a direction perpendicular to the loading platform. When the loading platform loads the work piece, the electrolyte flows through the hole and the electrolytic electrode moves in the hole in a variable speed to process the inside surface of the hole by electrolytic process, thereby forming a characteristic shape of the hole.

### BACKGROUND OF THE INVENTION

### Field of the Invention

The invention is related to an electrolytic processing apparatus, and more particularly, related to an apparatus capable of using the electrolysis method and the processing method to form the different shape holes.

### Description of the Prior Art

A spray nozzle is commonly used in mechanical parts and is widely used in various fields. The spray nozzles usually have small holes so as to make the liquid spray out through the atomizing form from the inside surface of the tube under the pressure. When the shape of the spray nozzle is a taper, the spray nozzle has higher spray pressure and better spray effect. For example, in the automotive industry, the taper micro hole of the spray nozzle on the diesel engine is helpful to promote the fuel atomization effect so as to improve fuel combustion efficiency and reduce fuel exhaust volume. In the biomedical industry, drugs can be sprayed on the heart catheter stent through the taper micro holes to prevent the blood vessel from thrombosis in heart catheter stent. In the semiconductor industry, the etching solution can be sprayed on the material to be removed through a spray nozzle with the taper micro holes to improve processing accuracy.

Since the spray nozzle material is mostly corrosion-resistant, high temperature resistant, high hardness and high strength alloy steel, the taper micro holes are difficult to be formed by the traditional mechanical processing method. Although the efficiency of the micro holes formed by the electrical discharge machining method is high, the discharge electrode will be loss so as to affect the shape and accuracy of the micro holes. Furthermore, the existing technology can only process taper micro holes. Hence, when the design or structure requires inverted taper micro holes, or even the inside surface of the micro holes needs to be processed into a specific shape, the existing technology cannot achieve this goal.

Therefore, it is necessary to develop a new type of electrochemical machining equipment, which can effectively process the hole shape of the work piece according to the design requirements to solve the problems of the prior art.

### SUMMARY OF THE INVENTION

In view of this, the present invention provides an electrolytic processing apparatus to solve the problem of the prior art.

According to an embodiment of the present invention, an electrolytic processing apparatus is configured for processing a hole of the work piece. The electrolytic processing apparatus comprises a work platform, an electrolyte providing device and an electrolytic electrode. The work platform comprises a loading platform and a flow channel above the loading platform; the loading platform is configured to load the work piece; and the position of the flow channel is corresponding to the hole of the work piece when the loading platform loads the work piece. The electrolyte providing device is connected to the flow channel to provide an electrolyte to the hole through the flow channel. The electrolytic electrode is configured relatively to the work platform to move in a direction perpendicular to the loading platform. Wherein, when the loading platform of the work platform loads the work piece, the electrolyte provided by the electrolyte providing device flows through the hole and the electrolytic electrode moves in the hole with a variable speed, so as to process the inside surface of the hole to form a characteristic shape of the hole.

Wherein, the electrolytic electrode comprises a main body and an insulating layer, the insulating layer covers a lateral surface of the main body to cause one end of the main body to be exposed and form a processing part, and the material of the insulating layer is epoxy resin.

Wherein, the variable speed comprises a first variable speed and a second variable speed, the electrolytic electrode moves in the hole with the first variable speed firstly and then moves in the hole with the second variable speed, and the first variable speed is greater than the second variable speed.

Wherein, the electrolytic electrode rotates with a speed and moves in the hole with the variable speed at the same time.

The electrolytic processing apparatus of the present invention further comprises a power supply unit coupled to the work piece and the electrolytic electrode, and the power supply unit provides a positive electricity to the work piece and provides a negative charge to the electrolytic electrode.

The electrolytic processing apparatus of the present invention further comprises a drill configured relatively to the work platform for drilling the work piece at a processing position to form the hole.

The electrolytic processing apparatus of the present invention further comprises a controller coupled to the drill and the electrolytic electrode for controlling the drill and the electrolytic electrode to process the work piece at the processing position.

In another embodiment, the present invention provides an electrolytic processing method to solve the problem of the prior art.

According to another embodiment of the present invention, the electrolytic processing method comprises the following steps: preparing a electrolytic electrode; setting a work piece with a hole on a loading platform of the work platform, wherein the work platform comprises a flow channel, and the position of the flow channel is corresponding to the position of the hole; providing an electrolyte through the flow channel and the hole when the electrolytic electrode is arranged in the hole; and the electrolytic electrode moving in the hole with a variable speed so as to process the inside surface of the hole to form a characteristic shape of the hole.

Wherein, the step of preparing the electrolytic electrode further comprises the following steps: forming an insulating layer covering the outside of electrolytic electrode, and grinding the insulating layer of the processing sector of the electrolytic electrode. The electrolytic electrode moves in the hole with the variable speed so as to electrolyze and process the inside surface of the hole to form the characteristic shape of the hole, namely, further comprising that the electrolytic electrode moves in the hole with the variable speed, and the work piece electrolyzes the inside surface of the hole to form the characteristic shape of the hole.

In another embodiment, the electrolytic processing method further comprises following step: drilling the work piece to form the hole.

Wherein, the electrolytic electrode moves in the hole with the variable speed so as to electrolyze and process the inside surface of the hole to form the characteristic shape of the hole, further comprising that the electrolytic electrode moves in the hole with the first variable speed firstly and then moves in the hole with the second variable speed so as to process the inside surface of the hole by the electrolytic process to form a characteristic shape of the hole, wherein the first variable speed is greater than the second variable speed.

As stated above, the electrolytic processing apparatus of the present invention can process holes of various required shapes through electrodes insulated on the circumference and moving at variable speeds. Furthermore, the electrolytic processing apparatus can perform drilling and electrochemical processing at the same processing position to improve efficiency and save costs.

### BRIEF DESCRIPTION OF THE APPENDED DRAWINGS

Some of the embodiments will be described in detail, with reference to the following figures, wherein like designations denote like members, wherein:

FIG. 1 is a diagram illustrating an electrolytic processing apparatus according to an embodiment of the present invention.

FIG. 2 is a sectional diagram illustrating the work platform and work piece according to FIG. 1.

FIG. 3 is a sectional diagram illustrating the electrolytic electrode and work piece in electrolyze according to FIG. 1.

FIG. 4 is a step flow chart of the method of an electrolytic processing method according to an embodiment of the present invention.

FIG. 5 is a step flow chart of the method of an electrolytic processing method according to an embodiment of the present invention.

FIG. 6 is a step flow chart of the method of an electrolytic processing method according to an embodiment of the present invention.

FIG. 7 is a diagram illustrating an electrolytic processing method according to an embodiment of the present invention.

FIG. 8 is a step flow chart of the method of an electrolytic processing method according to an embodiment of the present invention.

### DETAILED DESCRIPTION OF THE INVENTION

In order to make advantages, spirit and character of the present invention more easily, it will be described and discussed in detail by reference attached figure with embodiment. It is worth nothing that theses embodiment only replaced of the invention. But it can be implemented in many different forms and is not limited to the embodiments which described in this specification. In contrast, these embodiments are provided to make the public content of the present invention more thorough and comprehensive.

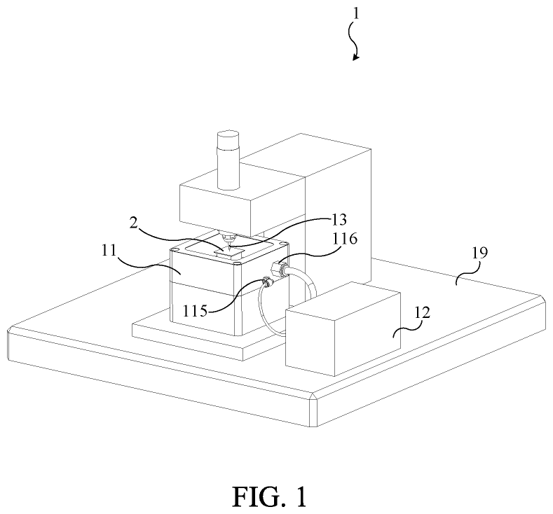

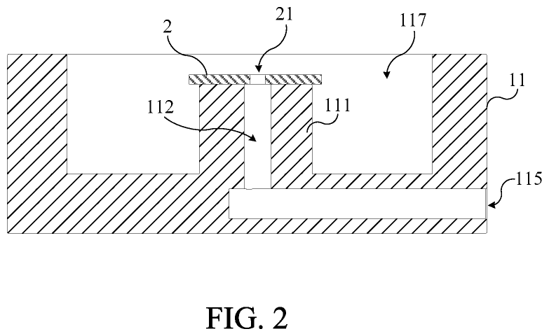

Please refer to FIG. 1 and FIG. 2. FIG. 1 is a diagram illustrating an electrolytic processing apparatus according to an embodiment of the present invention. FIG. 2 is a sectional diagram illustrating the work platform and work piece according to FIG. 1. As shown in FIG. 1, the electrolytic processing apparatus 1 of the present embodiment is configured to process the hole 21 on the work piece 2, which comprises work platform 11, the electrolyte providing device 12 and electrolytic electrode 13. The working platform 11 comprises the loading platform 111 is configured to load work piece 2. The electrolyte providing device 12 is connected to the work platform 11 to provide an electrolyte flowing to the work platform 11. The electrolytic electrode 13 is configured relatively to the work platform to move in a direction perpendicular to the loading platform.

In this embodiment, the electrolytic processing apparatus 1 can comprise a sole plate 19, a work platform 11, an electrolyte providing device 12 and electrolytic electrode 13, which all may be set on the sole plate 19. The work platform 11 can be fixed on the sole plate 19 with a locked manner, and the work piece 2 can be, but not limited to, fixed on the loading platform 111 with a locked or clamped manner. As shown in FIG. 2, the work platform 11 further comprises the flow channel 112 on the loading platform 111. In this embodiment, the flow channel 112 is a blind hole and set on the side of the loading platform 111 and the work piece 2. Furthermore, the position of the flow channel 112 is corresponding to the hole of the work piece 2 when the loading platform loads the work piece. Therefore, the flow channel 112 and work piece 2 are connected to each other when the work piece 2 is fixed on the loading platform 111. Moreover, the measurement of the flow channel 112 may be larger than the measurement of the hole 21 of the work piece 2. In the practical application, the shape and the form of the flow channel 112 are not limited to this and can be determined according to requirements.

The electrolyte providing device 12 can connect to the flow channel 112 of the work platform 11 and can provide electrolyte to the flow channel 112. In this embodiment, the work platform 11 comprises the electrolyte inlet 115 connecting to the electrolyte providing device 12 and the electrolyte inlet 115 connecting to the flow channel 112. Hence, the electrolyte providing device 12 can provide electrolyte to the hole 21 of the work piece 2 through the electrolyte inlet 115 and flow channel 112 when the electrolyte providing device 12 provides electrolyte to the work platform 11. Furthermore, the work platform 11 can comprise the electrolyte outlet 116 and the recess 117. The recess 17 is arranged around the outside of the loading platform 111; the electrolyte outlet 116 is connected to the recess 117 and is further connected to the electrolyte providing device 12. When the electrolyte provided by the electrolyte providing device 12 flows through the hole of the work piece 2 from the flow channel 112, the electrolyte further flows to the recess 117 and returns to the electrolyte providing device 12 through the electrolyte outlet 116. Moreover, the electrolyte provided by the electrolyte providing device 12 can sequentially flow through the electrolyte inlet 115, the flow channel 112, the hole 21 of the work piece 2, recess 117, and the electrolyte outlet 116 to form a loop. In the practical application, the electrolyte flowing out from the recess 117 may not flow back to the electrolyte providing device 12.

In this embodiment, the electrolytic electrode 13 is arranged above the working platform 11 and moves in a direction close to and away from the working platform 11. Further, when the work piece 2 is fixed on the loading platform 111, the position of the electrolytic electrode 13 is corresponding to the position of the hole 21 of the work piece 2. In the practical application, the electrolytic electrode 13 can be driven by a motor, an air cylinder, or a screw. In this embodiment, except that the electrolytic electrode 13 corresponds to the hole 21 of the work piece 2, the position of the electrolytic electrode 13 also corresponds to the flow channel 112. Therefore, the electrolytic electrode 13 can extend to or penetrate into the hole 21 of the work piece 2 for electrolyzing and processing.

In this embodiment, the electrolytic processing apparatus 1 further comprises a power supply unit (not shown in the figure) coupled to the work piece 2 and the electrolytic electrode 13. The power supply unit can provide positive charge to the work piece 2 and provide negative charge to the electrolytic electrode 13. In practical application, the power supply unit can be DC power supply. When the electrolytic electrode 13 moves to the hole 21 of the work piece 2, the electrolytic electrode 13 and the work piece 2 generate the electrochemistry reaction through the electrolyte in the hole 21 so as to process the inside surface of the hole 21 to form a characteristic shape of the hole.

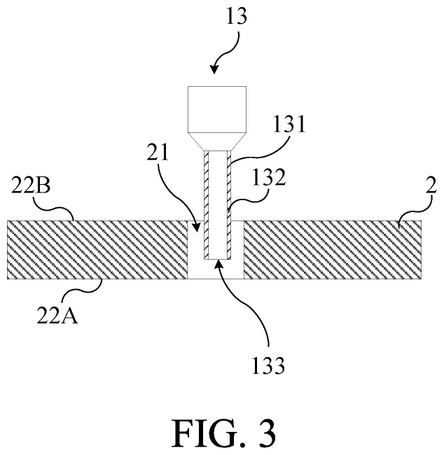

Please refer to FIG. 3; FIG. 3 is a sectional diagram illustrating the electrolytic electrode and work piece in electrolyze according to FIG. 1. In this embodiment, the electrolytic electrode 13 further comprises a main body 131 and an insulating layer 132. The insulating layer 132 covers the lateral surface of the main body 131, but the insulating layer 132 does not cover the end surface of the main body 131 of the electrolytic electrode 13 to cause one end of the main body to be exposed and formed a processing part 133. In practical application, the main body 131 of the electrolytic electrode 13 may be metal material or conductive material, and the material of the insulating layer 132 is non-conductive material, such as an epoxy resin. Since the insulating layer 132 is not conductive when the electrolytic electrode 13 extends to or penetrates into the hole 21 of the work piece 2 to process the electrolyze, the outer peripheral surface of the main body 131 of the electrolytic electrode 13 will not generate electrochemical reaction with the hole 21. Only the processing part 133 is located on the end surface of the main body 131 will generate an electrochemical reaction through the electrolyte and the inner of the hole 21 of the work piece 2. Therefore, when the electrolytic electrode 13 moves and electrolyzes in the hole 21 of the work piece 2, the processing part 133 of the electrolytic electrode 13 and the lateral of the hole 21 generate an electric field and electrochemical reaction so as to make the lateral of the hole 21 generate a dent by the electrolyzing. Moreover, when the electrolytic electrode 13 moves, the processing part 133 of the electrolytic electrode 13 electrolysis, along with the position of the processing part 133 on the lateral of the hole, forms a characteristic shape.

In this embodiment, the electrolytic electrode 13 rotates with a speed and moves in the hole 21 of the work pieces 2 to process and electrolyze. In practical application, the electrolytic electrode 13 can rotate with a speed above 1000 rpm, 2000 rpm, 3000 rpm, 4000 rpm or 5000 rpm. When the electrolytic electrode 13 rotates in the hole, the electrolytic electrode 13 can drive the electrolyte between the electrolytic electrode 13 and the hole 21 to flow uniformly so as to make the electrolytic processing reaction more uniform. Therefore, the electrolytic electrode 13 can uniformly electrolyze and process the holes to reduce and remove the burrs of the holes to improve efficiency and processing quality.

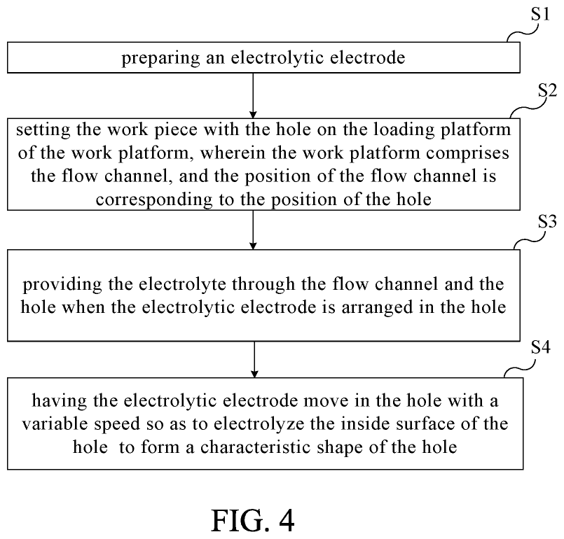

Please refer to FIG. 1 to FIG. 4. FIG. 4 is a step flow chart of the method of an electrolytic processing method according to an embodiment of the present invention. In this embodiment, an electrolytic processing method comprises the following steps: step S1: preparing an electrolytic electrode 13; step S2: setting the work piece 2 with the hole 21 on the loading platform 111 of the work platform 11, wherein the work platform 11 comprises the flow channel 112, and the position of the flow channel 112 is corresponding to the position of the hole 21; step S3: providing the electrolyte through the flow channel 112 and the hole 21 when the electrolytic electrode 13 is arranged in the hole; step S4: having the electrolytic electrode 13 move in the hole with a variable speed so as to electrolyze the inside surface of the hole 21 to form a characteristic shape of the hole 21. In practical application, the electrolytic electrode 13 prepares the processing part 133 and is arranged above the loading platform 111. The hole 21 of the work piece 2 and the flow channel 112 of the work platform 11 are connected to each other, after the work piece 2 is fixed on the loading platform 111. Then, the electrolyte providing device 12 provides the electrolyte, and the electrolyte flows from the flow channel 112 toward the hole 21 in a variable speed. At this time, the power supply unit 15 turns on the power and the electrolytic electrode 13 moves in the hole 21 containing the electrolyte solution to electrolyze and process the lateral of the hole 21 to form a characteristic shape. The variable speed can be acceleration, but not limited to this; the variable speed can also be composed of multiple different speeds.

The aforementioned characteristic shape can be determined according to the moving direction and variable speed of the electrolytic electrode covered by the insulating layer covering outer surface of the main body. As shown in FIG. 3, in this embodiment, the work piece 2 comprises a first surface 22A and a second surface 22B. When the electrolytic electrode 13 penetrates the hole 21 of the work piece 2 and moves from the second surface 22B to the first surface 22A in a positive acceleration, the characteristic shape of the hole 21 is inverted taper. In practical application, since the moving speed of the electrolytic electrode 13 in the hole 21 is inversely proportional to the electrochemical reaction, the electrolytic electrode 13 processes the hole 21 and the electrolytic electrode 13 moves from the second surface 22B to the first surface 22A with a speed of slow to fast. The initial moving speed of the electrolysis electrode 13 is relatively small, and the depression on the lateral surface of the hole 21 close to the second surface 22B is relatively large. In other words, the electrochemical reaction of the electrolytic electrode 13 in the hole 21 close to the second surface 22B is the largest. When the electrolytic electrode 13 moves to the first surface 22A, the moving speed of the electrolysis electrode 13 is accelerated so as to decrease the electrochemical reaction, and thus an inverted taper hole is generated. The characteristic shape of the hole is not limited to the inverted taper shape, and may also be a positive taper shape, an hourglass shape, a gourd shape, etc. When the electrolytic electrode 13 passes through the hole 21 of the work piece 2 and moves from the second surface 22B to the first surface 22A in a negative acceleration, the characteristic shape of the hole 21 is a positive taper shape. In addition, when the electrolytic electrode 13 sequentially moves from the second surface 22B to the first surface 22A in a constant velocity, constant acceleration, constant velocity, constant deceleration, and constant velocity, the characteristic shape of the hole 21 is a gourd shape.

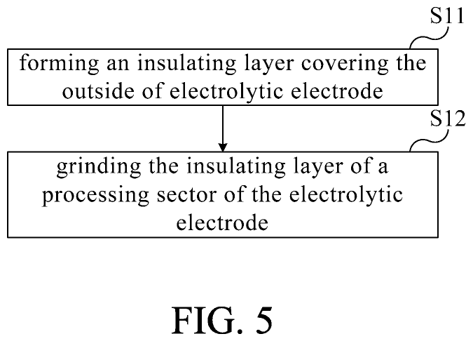

Please refer to FIG. 3, FIG. 4. and FIG. 5. FIG. 5 is a step flow chart of the method of the electrolytic processing method according to an embodiment of the present invention. In this embodiment, step S1 in FIG. 4 may further comprise: step S11: forming an insulating layer 132 covering the outside of the electrolytic electrode 13; and step S12: grinding the insulating layer 12 of the processing p 133 of the electrolytic electrode 13. In practical application, the electrolytic electrode 13 can be electroplated on the lateral surface of the main body 131 by the non-conductive material to form an insulating layer. Then, the electrolytic electrode 13 can be grinded by a grinder so as to grind the end of the insulating layer of the electrolytic electrode 13 to be exposed the end of the metal material to form the processing part 133. In this embodiment, the shape of the processing part 133 of the electrolytic electrode 13 is a plane. However, it is not limited to this in practice, and the shape of the processing part may also be a convex point, a circular arc or a cone.

And the electrolytic electrode moves in the hole with the variable speed so as to electrolyze and process the inside surface of the hole to form the characteristic shape of the hole, further comprising:

the electrolytic electrode moving in the hole with the variable speed, the work piece electrolyzing the inside surface of the hole to form the characteristic shape of the hole.

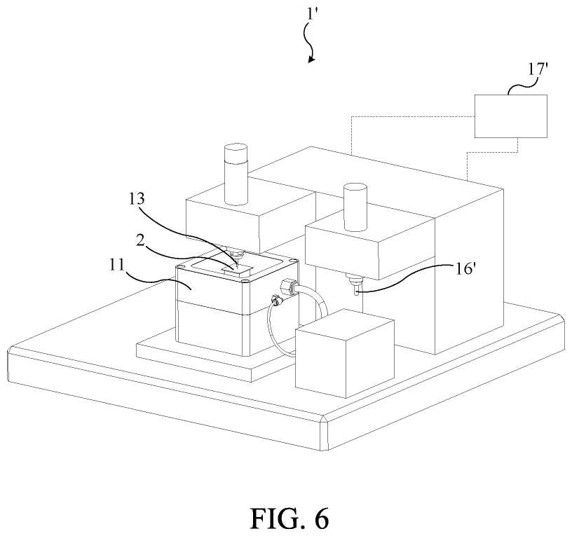

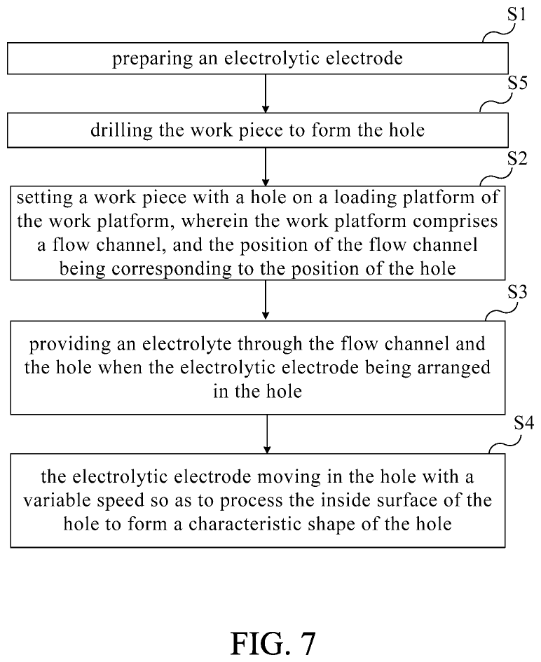

Please refer to FIG. 6 and FIG. 7. FIG. 6 is a step flow chart of the method of the electrolytic processing method according to an embodiment of the present invention. FIG. 7 is a diagram illustrating an electrolytic processing method according to an embodiment of the present invention. The processing method of FIG. 7 can be achieved by the electrolytic processing apparatus 1′ of FIG. 6. The difference between this embodiment and the above embodiments is that the electrolytic processing apparatus 1′ of this embodiment further includes a drill 16′ and a controller 17′. In this embodiment, the drill 16′ is configured to drill the work piece 2 to form the hole. The controller 17′ is coupled to the drill 16′ and the electrolytic electrode 13. In practical application, the drill 16′ can move closer to and away from the working platform 11, the drill 16′ and the electrolytic electrode 13 are movably set on the working platform 11. The controller 17′ can be a CNC controller and an executable CNC program. Therefore, the controller 17′ can control the drill 16′ and the electrolytic electrode 13 above the work platform 11. Furthermore, the controller 17′ control the drill 16′ to move above the work piece 2 and drills the work piece 2 to form the hole 21 (step S5 in FIG. 7), the controller 17′ controls the drill 16′ to move away from the work piece 2, and then the controller 17′ controls the electrolytic electrode 13 to move to the position of the drill 16′ processing the work piece 2 to electrolyze and process the hole of the work piece 2. In another embodiment, the controller 17′ change the drill 16′ and the electrolytic electrode 13 by changing the tool so as to make the drill 16′ and the electrolytic electrode 13 process the work piece 2 at the same processing position. In practical application, the controller 17′ can control the drill 16′ to drill the work piece 2 to generate the hole 21 by the CNC program, and then the controller 17′ executes the CNC program to set the electrolytic electrode 13 at the position where the drill 16′ processes the work piece 2, and then the electrolytic electrode 13 electrolyzes and processes in the hole 21 which is formed by the drill 16′ processing the work piece 2. Therefore, the drill 16′ and the electrolytic electrode 13 are kept in the center of the hole of the work piece 2 when the work piece 2 is processed to maintain the processing accuracy, so as to improve the efficiency and lower the cost. Please note that the electrolytic electrode 13 of this embodiment includes the insulating layer and the processing part.

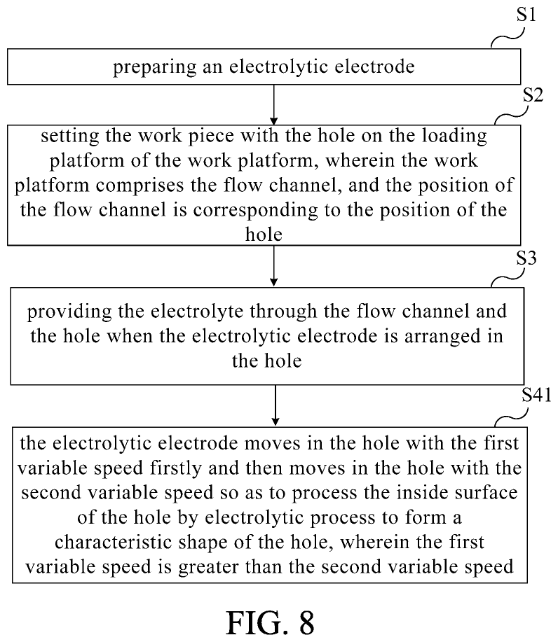

The aforementioned electrolysis electrode can move in the hole in one direction and can also move in the hole multiple times. Please refer to FIG. 3 and FIG. 8. FIG. 8 is a step flow chart of the method of the electrolytic processing method according to an embodiment of the present invention. In this embodiment, as step S41, the variable speed includes the first variable speed and the second variable speed. The electrolytic electrode 13 moves in the hole 21 with a first variable speed firstly, and then moves in the hole 21 with the second variable speed. Among them, the first variable speed is greater than the second variable speed. In practical application, when the hole 21 of the work piece 2 is with poor quality or burrs, the electrolytic electrode 13 can first modify the shape of the hole 21 and remove the burrs with the first variable speed. Then, the electrolytic electrode 13 is processed through the hole 21 with the second variable speed to ensure the quality of the processing and improve the efficiency.

As stated above, the electrolytic processing apparatus of the present invention can process holes of various required shapes through the electrodes insulated on the peripheral surface and moving at variable speeds, and the electrolytic electrodes can electrolytically process the holes uniformly by rotating to improve processing quality and efficiency. Furthermore, the electrolytic processing apparatus can also perform drilling and processing at the same position to lower the costs.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electrolytic processing apparatus configured for processing a hole of a work piece, the electrolytic processing apparatus comprising:
a work platform comprising a loading platform and a flow channel above the loading platform, the loading platform being configured to load the work piece, the position of the flow channel being corresponding to the hole of the work piece when the loading platform loads the work piece;
an electrolyte providing device connected to the flow channel to provide an electrolyte to the hole through the flow channel; and
an electrolytic electrode configured relatively to the work platform to move in a direction perpendicular to the loading platform;
wherein, when the loading platform of the work platform loads the work piece, the electrolyte provided by the electrolyte providing device flows through the hole and the electrolytic electrode moves in the hole with a variable speed, so as to process the inside surface of the hole to form a characteristic shape of the hole.

2. The electrolytic processing apparatus of claim 1, wherein the electrolytic electrode comprises a main body and an insulating layer, the insulating layer covers a lateral surface of the main body to cause one end of the main body to be exposed and form a processing part.

3. The electrolytic processing apparatus of claim 2, wherein the material of the insulating layer is epoxy resin.

4. The electrolytic processing apparatus of claim 1, wherein the variable speed comprises a first variable speed and a second variable speed, the electrolytic electrode moves in the hole with the first variable speed firstly and then moves in the hole with the second variable speed, the first variable speed is greater than the second variable speed.

5. The electrolytic processing apparatus of claim 1, wherein the electrolytic electrode rotates with a speed and moves in the hole with the variable speed at the same time.

6. The electrolytic processing apparatus of claim 1, further comprising a power supply unit coupled to the work piece and the electrolytic electrode, the power supply unit providing a positive electricity to the work piece and providing a negative charge to the electrolytic electrode.

7. The electrolytic processing apparatus of claim 1, further comprising a drill configured relatively to the work platform for drilling the work piece at a processing position to form the hole.

8. The electrolytic processing apparatus of claim 7, further comprising a controller coupled to the drill and the electrolytic electrode for controlling the drill and the electrolytic electrode to process the work piece at the processing position.

9. An electrolytic processing method, comprising the following step:
preparing an electrolytic electrode;
setting a work piece with a hole on a loading platform of the work platform, wherein the work platform comprises a flow channel, and the position of the flow channel being corresponding to the position of the hole;
providing an electrolyte through the flow channel and the hole when the electrolytic electrode being arranged in the hole;
the electrolytic electrode moving in the hole with a variable speed so as to process the inside surface of the hole to form a characteristic shape of the hole.

10. The electrolytic processing method of claim 9, wherein the step of preparing the electrolytic electrode, further comprises following step:
forming an insulating layer covering the outside of electrolytic electrode; and
grinding the insulating layer of a processing sector of the electrolytic electrode;
And the electrolytic electrode moving in the hole with the variable speed so as to electrolyze and process the inside surface of the hole to form the characteristic shape of the hole, further comprising:
the electrolytic electrode moving in the hole with the variable speed, the work piece electrolyzing the inside surface of the hole to form the characteristic shape of the hole.

11. The electrolytic processing method of claim 9, further comprising following step:
drilling the work piece to form the hole.

12. The electrolytic processing method of claim 9, wherein the electrolytic electrode moves in the hole with the variable speed so as to electrolyze and process the inside surface of the hole to form the characteristic shape of the hole, further comprising:
the electrolytic electrode moves in the hole with the first variable speed firstly and then moves in the hole with the second variable speed so as to process the inside surface of the hole by electrolytic process to form a characteristic shape of the hole, wherein the first variable speed is greater than the second variable speed.
